(19) United States
(12) Patent Application Publication
(10) Pub. No.: US 2011/0034210 A1
(43) Pub. Date: Feb. 10, 2011

(54) COMMUNICATION DEVICE AND STORAGE DEVICE PROTOCOL

(75) Inventors: Erhard Schreck, San Jose, CA (US); Tim R. Glassburn, Milpitas, CA (US); Don Brunnett, Pleasanton, CA (US); Mike Lee, San Jose, CA (US)

Correspondence Address: HENSLEY KIM & HOLZER, LLC, 1660 LINCOLN STREET, SUITE 3000, DENVER, CO, 80264, US

(73) Assignee: SEAGATE TECHNOLOGY LLC, Scotts Valley, CA (US)

(21) Appl. No.: 12/909,558

(22) Filed: Oct. 21, 2010

Related U.S. Application Data
(63) Continuation of application No. 11/430,188, filed on May 8, 2006.
(60) Provisional application No. 60/678,520, filed on May 6, 2005.

(51) Int. Cl. H04M 1/00

(52) U.S. Cl. 455/556.1; 455/567

(57) ABSTRACT

A cellular telephone is configured to perform procedures to protect against malfunction or damage to an HDD or other mass storage device in the cell phone, in response to receiving an indication of an incoming call. The protection procedures can include delaying one or more cell phone operations, and/or sending instructions to an HDD or other mass storage device including instructions to complete an operation, suspend an operation, park a head and/or spin down an HDD. In a cell phone which provides for extended playback, e.g., of audio or video, the cellular telephone preferably is configured to avoid interruptions of playback, e.g., during suspension or HDD operation.

### CROSS-REFERENCE TO RELATED APPLICATIONS

This application is a continuation application of U.S. patent application Ser. No. 11/430,188, titled “Cell Phone Ring and HDD Protocol,” which claims priority on the basis of U.S. Provisional Patent Application Ser. No. 60/678,520 filed May 6, 2005, titled “Cell Phone Ring and HDD Protocol” which is incorporated herein by reference in its entirety.

### FIELD OF THE INVENTION

The present invention relates to a method and apparatus for use in connection with a cellular telephone (cell phone) having a hard disk drive (HDD), and in particular to a method and apparatus for providing a ring and/or vibrate protocol which can reduce or eliminate certain potential problems with HDD operation.

### BACKGROUND INFORMATION

There are a number of potentially useful features and capabilities for a cellular telephone (or similar personal communication/playback device) which has an HDD near, on or (preferably) within the housing of a cellular telephone (an “HDD cell phone”). HDD technology can be used to provide a relatively large amount of memory for a cell phone while still providing a cell phone which is small, lightweight, relatively inexpensive and with relatively low power consumption. Provision of large memory capacity is especially useful for cellular telephones which have the ability to playback music or other stored audio and/or playback of still or moving images (graphics, pictures, video, etc.). However, it is believed that, for at least some cell phone designs and/or operations, there is a potential for previous procedures or protocols to disrupt the desired normal operation of the HDD and even the potential to cause damage to the HDD or other cell phone components. It is believed that one or more signaling operations, including providing a ring or vibrate signal, are temporally and/or causally associated with some potential HDD errors or damage. Accordingly, it would be desirable to provide a method and apparatus which can reduce or eliminate errors or damage to, or caused by, operation of an HDD cell phone, especially those associated with ring, vibrate or other signaling operations.

In some cell phones or similar devices, an HDD can be usefully involved in a playback which consumes an extended time (such as a few seconds, but more commonly at least one minute) including playback of songs or other music, movies or other video and the like. In general, in such applications, it is desired to have the ability to provide the extended-time playback in an uninterrupted manner, i.e. substantially without human-perceptible pauses in the playback. Accordingly, it would be useful to provide an apparatus and method which can avoid malfunction or damage in or by the HDD of an HDD cell phone while avoiding interruption of any playback that may be occurring.

In general, it is desirable to provide HDD's having a relatively long operating lifetime. Accordingly, HDD's are preferably designed so as to, on average, provide a relatively large number of operations before failure becomes likely. Among these operations are spin up/spin down operations and/or movement of an actuator arm into or out of a park or other safe position (“unload/load”). Accordingly, it would be useful to provide an apparatus and method for substantially avoiding or eliminating malfunction or damage in the HDD of an HDD cell phone without unnecessarily performing operations which are related to the expected useful lifetime of the HDD.

### SUMMARY

The present invention includes a recognition of the existence, source and nature of problems in previous approaches, including as described herein. According to one embodiment of the present invention, one or more operations which normally follow the HDD cell phone's receipt of an indication of an incoming call is delayed at least long enough to reduce or eliminate the risk of malfunction of, or damage to, the HDD of an HDD cell phone. For example, the postponed procedures can include the generation of a ring tone and/or a vibration signal, and/or one or more procedures which are associated with, or which normally precede, the ring tone or vibration signal. In some configurations, the delay itself may suffice to avoid HDD malfunction or damage. However, embodiments of the present invention also include an apparatus and method which involves one or more commands or signals between the HDD and the main cell phone unit (e.g., the cell phone excluding the HDD).

The main cell phone unit may issue an instruction to the HDD which can result in, for example, completing one or more current read and/or write operations, suspending further read and/or write, or other, operations and/or placing the HDD in a safe configuration such as parking the heads, positioning heads over safe locations and/or pausing or spinning down the HDD. In some configurations, there is a pause or spin down of the HDD, in response to an indication of an incoming call, only when such action is necessary to avoid malfunction or damage.

According to one embodiment of the invention, at least some types of data read from the HDD are stored in a buffer prior to outputting to a speaker, screen or other device and the buffer has sufficient capacity to avoid interruption of such output during a pause or suspension of HDD operation.

According to one embodiment of the invention, a cellular telephone is configured to perform procedures to protect against malfunction or damage in an HDD or other mass storage device in the cell phone, in response to receiving an indication of an incoming call. The protection procedures can include delaying one or more cell phone operations, and/or sending instructions to a HDD or other mass storage device, potentially including instructions to complete an operation, suspend an operation, park a head and/or spin down an HDD. In a cell phone which provides for extended playback, e.g., of audio or video, the cellular telephone, preferably, is configured to avoid interruptions of playback, e.g., during suspension of HDD operation.

### BRIEF DESCRIPTION OF THE DRAWINGS

FIG. 1 is a block diagram of selected components of an HDD cell phone of a type useful in connection with embodiments of the present invention;

FIG. 2 is a flowchart of a procedure in response to an indication of an incoming call, according to an embodiment of the present invention;

FIG. 3 is a flowchart of a procedure which can avoid playback interruption, according to an embodiment of the present invention; and,

FIG. 4 is a flowchart of a procedure which can be used according to an embodiment of the present invention.

### DETAILED DESCRIPTION OF THE PREFERRED EMBODIMENTS

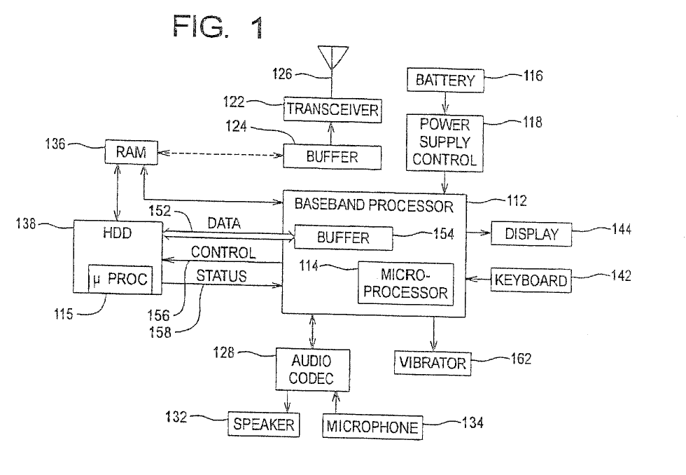

FIG. 1 illustrates selected components of a cell phone which can be used according to an embodiment of the present invention. The base band processor 112 typically having a microprocessor 114, and powered by a battery 116 and power supply control 118 communicates with a transceiver 122, typically via a data buffer 124 for sending or receiving messages using antenna 126, typically by modulated electromagnetic signals. The baseband processor 112 can be configured to route audio signals via, e.g., an audio code-decode (codec) 128 for playback on a speaker 132 or received through a microphone 134. The microprocessor 114 can, in the depicted embodiment, store and retrieve data 20 either in a volatile memory such as ram 136 or a mass storage device 138, including for purposes described more thoroughly below. HDDs have been developed which have sufficient capacity and yet are relatively small (such as occupying a volume of less than about thirteen cubic centimeters), lightweight (such as less than about fifteen grams), with relatively low power consumption (such as less than about two hundred fifty milliamps average write current), and which are relatively inexpensive, as compared to other storage options with comparable capacities. The typical cell phone will have an input device such as a keyboard 142 for “dialing” phone numbers, commands and the like, and an output device such as an LCD or other display 144 e.g., for displaying operating status, caller identification and the like. In some cell phones, the display 144 can be used to display still pictures and/or video, which may be received as, or may be part of, messages through the transceiver 122 and/or maybe stored, e.g., on mass storage device 138. The HDD 138 provides data 152 to a processor buffer 154 and receives control signals 156 (e.g. over a signal line) and, in some configurations, provides status and/or acknowledge signals to 158 the processor 112. In the depicted HDD cell phone, the processor 112 can activate or otherwise control a vibrator 162 e.g. for signaling the user. Unless otherwise indicated, as used herein, “vibrator”, “vibrate”, and “vibration” refer to the deliberate creation of a vibration in the cell phone as an alternative to (or in addition to) an audible ring signal.

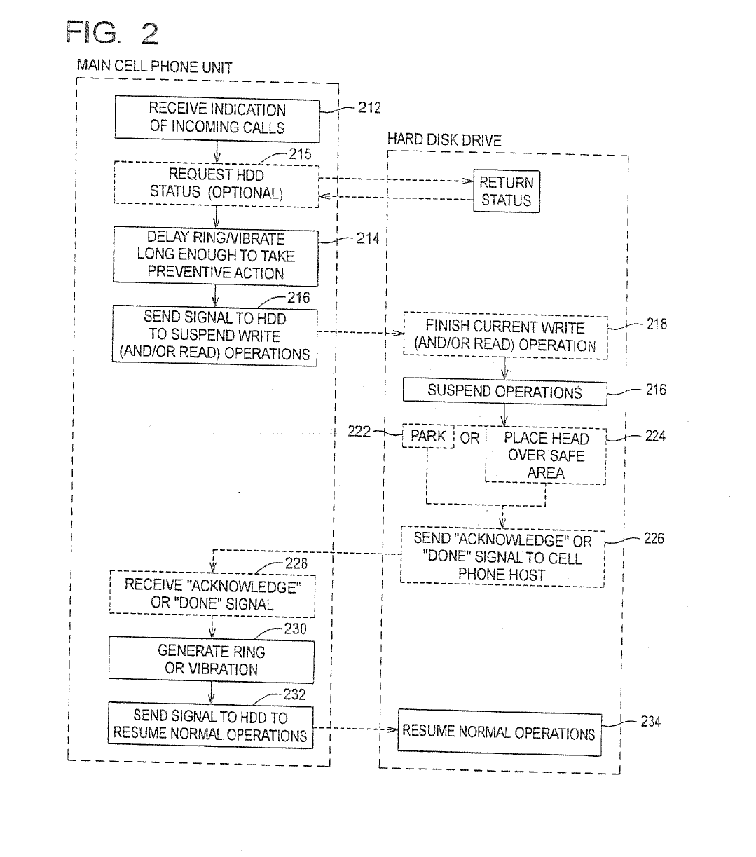

In the embodiment illustrated in FIG. 2, in response to receiving an indication of incoming calls 212, the main cell phone unit optionally requests status 215 from the 20 HDD. If the HDD status is such that there is little or no risk of HDD malfunction or damage, the procedure of FIG. 2 can be terminated (i.e. it will not be necessary to initiate a delay, or to suspend any operations). However, if there is a potential for HDD malfunction or damage, the processor 112 delays 214 a ring and/or vibrate and/or some or all processing that normally precedes a ring or vibrate and/or another cell phone operation which is associated with an indication of an incoming call. The potential for HDD malfunction or damage may be associated with a ring, with a vibrate, or both. In general, the ring is temporally or causally associated with a potential for a malfunction of one or more HDD functions including potential errors in read data or write data, and errors in positioning the actuator arm (which can result in read data errors or write data errors). Without wishing to be bound by any theory, it is believed that some cell phone designs or protocols including, e.g., GSM (Global System for Mobile communication) have an undesirably high susceptibility to the creation of an electromagnetic interference (EMI) pulse (generally, preceding a ring) that causes or contributes to these potential problems. Without wishing to be bound by any theory, it is believed that the EMI pulse is related to some of the processing which occurs (potentially including communication between the cell phone and the local cell tower) in response to the receipt of an incoming call communication and prior to a production of a ring. Errors in positioning the actuator arm have the potential for positioning the head so as to overwrite or otherwise damage user data, operating parameter data which may be stored on the disk or other important data. There is also the potential for an EMI pulse or other event to cause the actuator arm to move to a crash stop or other limiting position such that there is potential for physical damage to the HDD.

Depending, e.g., upon the cell phone protocol and design, the susceptibility of the HDD to malfunction or damage may differ depending upon the state of the cell phone. For example, in some HDD cell phones, there may be a relatively small potential for malfunction or damage when the HDD is in a “park” configuration (particularly if the arm or head is at least partially mechanically restrained), as compared to an HDD state in which the HDD is reading or writing. In some HDD cell phones, the potential for (or severity of) damage may (at least partially) depend on whether the HDD is performing a write, as opposed to a read, or other function. In one embodiment, the HDD cell phone is configured so that the processor 112 can receive (and/or request) information about the current status of the HDD, e.g., for use in determining what actions should be taken.

For some HDD cell phone designs, some benefits occur as a result of a delay or pause before proceeding with a ring or vibrate (and associated processing). For example, providing a pause (either for a predetermined period, or until a particular state of the HDD is achieved) may allow the HDD to complete an ongoing write (or other) operation. Accordingly one embodiment of the invention provides for inserting a pause before producing a ring and/or vibrate, and/or processing which normally precedes the ring and/or vibrate. However, many HDD designs allow the HDD to perform read and write operations (e.g., for maintenance purposes and the like) without first receiving a command from the host, and such operations may place the HDD in a state where there is substantial potential for HDD malfunction or damage. Furthermore, even in the absence of non-commanded HDD operations, there may still remain an undesirably high potential for malfunction or damage, during or following a pause. Accordingly, in some embodiments of the invention, other devices or procedures (in addition to, or in place of, a pause) are provided, e.g., by providing an appropriately configured or modified HDD interface protocol, as described more fully below.

In the case of a vibrate, there is a risk of malfunction or damage arising from the mechanical effects of the vibrator. It is believed that, at least for some protocols and designs of cell phones, the HDD is most susceptible to malfunction or damage when it is subjected to vibration during a write operation. Furthermore, in at least some HDD designs, data errors which occur during a read can be detected and/or corrected, whereas at least some errors that occur during a normal write (as opposed, e.g., to a write-verify) are not easily detected or corrected. Accordingly, although the present invention can be used to provide a pause or other procedures (including as described below) in response to an impending vibration, in one embodiment, one or more vibration mode protection procedures are implemented only if the HDD is in a write mode. Avoiding protection procedures which are unnecessary (i.e., where there is a lessened likelihood of malfunction or damage) can be especially helpful where the protection features involve a load/unload operation which can affect the expected HDD lifetime, as described more thoroughly below.

Because the potential for vibrator-induced damage does not occur until the processor instructs the vibrator to operate and because it is believed that, for at least some cell phone protocols and designs, the potential for an EMI pulse is substantial only in the period between receipt of an indication of an incoming call and the production of a ring (typically the first ring), creating a pause in the processing of the incoming call will suspend the risk of an EMI pulse or vibration for a period of time long enough to take preventive action as described below. Typically, the type of action best suited to avoiding malfunction or damage (e.g., during or following a pause) will, depending on the cell phone design and protocol, at least partially depend on the current state or operation of the HDD.

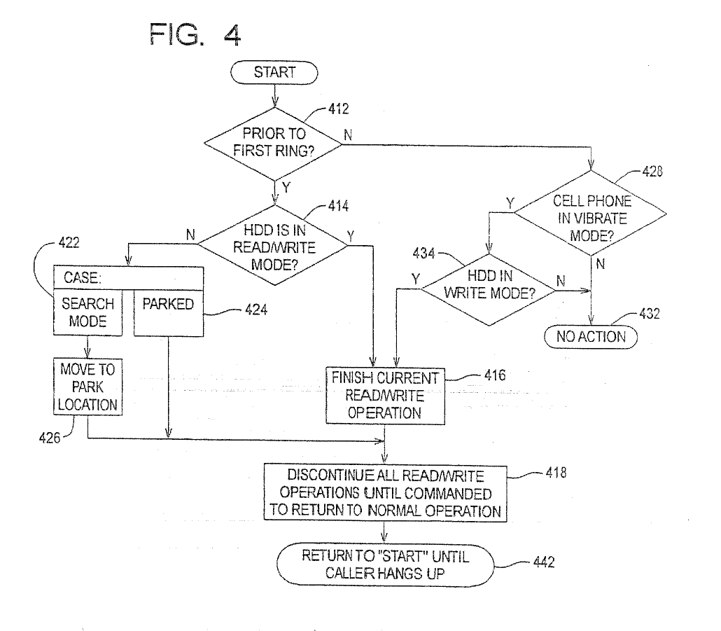

FIG. 4 is a flowchart illustrating one example of a process which can be used by the processor 112 to determine, on the basis of the cell phone and/or HDD state (and considering such factors as the cell phone design and protocol) which commands, if any, should be sent to the HDD in response to receiving a notice of an incoming call. The example illustrated in FIG. 4 could be used, e.g., in an HDD cell phone in which a pre-ring EMI has the potential to cause both data corruption and physical damage to the HDD in any non-parked cell phone HDD state (and in which the EMI pulse will not occur after the first ring) but in which the vibration (if activated) will, at most, cause an error in read/write data, and in which the HDD has error detect and correction for read data. This example is illustrative and those of skill in the art will understand how to design procedures (and/or modify the procedures of FIG. 4) to accommodate HDD cell phones which have other state-dependent potentials for malfunction or damage.

In the example of FIG. 4, if the first ring has not yet occurred 412, then, if the HDD is in a read or write mode 414, the current read or write information (e.g., reading of, or writing to, the current HDD sector) will be allowed to be completed 416 and the HDD will be configured to discontinue any further read or write operations (including those which could, under normal operating conditions, occur without an express command from the host) e.g. until such time as the HDD is commanded, by the host, to return to “normal operation” 418. If the HDD is not in read or write mode, and if it is in some configuration other than “parked” (such as in a search mode 422), the head will be moved to a park location 426. Whereupon (or if the head is already parked 424), the HDD will discontinue any read or write operations until commanded otherwise 418. If the first ring has already occurred 412 (and thus, in the present example, there is no further risk of the type of EMI pulse described herein), then it is determined whether the cell phone is in a vibrate mode 428. If not, no further action is necessary 432. If the phone is in vibrate mode, then it is determined whether the HDD is in write mode 434. If the HDD is not in write mode then no further action is necessary 432. If it is in write mode, the current sector write is completed 416 and then subsequent read/write 15 operations are discontinued 418 until commanded otherwise.

The process of FIG. 4 is one example of a decision process that can be used according to an embodiment of the present invention. Other procedures can be used, e.g. if the HDD cell phone has a different configuration or characteristics. For example, if it is difficult or infeasible for the cell phone host to determine the current status of the HDD, a procedure can be configured to always finish any current operations and then discontinue further operations until otherwise commanded. If the HDD cell phone is configured such that there is no substantial risk of a pre-ring EMI pulse, but only a potential for data errors from vibrate mode, a procedure could be used which includes substantially only certain portions (e.g., 428, 434, 432, 416 and 418) of the procedure depicted in FIG. 4. Those of skill in the art will understand how to design and/or modify a procedure (including, e.g., designing or modifying HDD firmware and/or circuitry) and/or design and/or modify a device for determining commands (if any) to send to the HDD in response to receipt of a notification of an incoming call, at least after understanding the present disclosure.

In the example of FIG. 4, certain procedures (e.g. 414, 422, 424, 426) will only be performed prior to the first ring 412. However, other procedures (e.g. 428, 432, 434, 416, 418) will be performed prior to each vibration (when the phone is in vibration mode), at least until the caller hangs up 442. Thus, the procedure of FIG. 4 is configured to substantially avoid parking the head for each ring and, instead, parks the head only when necessary, i.e., prior to the first ring (in some situations). This example is useful, as noted 15 above, for a configuration in which vibration mode can only result in corruption of data and will not cause the head to move to a crash stop or to undergo a head crash or other potentially damaging maneuver. (If the cell phone and HDD are configured such that there is a potential for this type of damage from a vibration, the procedure of FIG. 4 would preferably be modified to include parking the head prior to each vibration). In this way, unnecessary load/unload operations (and/or unnecessary spin up/spin down operations) are avoided. Since HDDs are typically designed to have at least (a large) minimum number of load/unload operations during the expected lifetime of the HDD, avoiding unnecessary load/unload operations is useful to avoid unnecessarily shortening the expected lifetime of the HDD.

In response to receiving one or more commands from the main cell phone unit, the HDD (depending upon the commands that are sent) will, in the configuration depicted in FIG. 2, optionally finish the current write (and/or read) operation 218 and suspend further operations 216. Optionally (and depending on the command sent and the configuration of the HDD) the head will be moved to a safe position, i.e., it will be parked 222 or placed over a safe area of the disk 224 (such as a landing zone or another area that is not used to store user data or system information or other designated non-critical region). Optionally, the HDD can be configured to send an “acknowledge” or “done” signal to the cell phone host 226. The main cell phone unit can use the receipt of the “acknowledge” or “done” signal 228 as a basis for determining that it is now safe to end the delay period 214 and to proceed with processing the incoming call and/or producing a ring or vibration 230. In the embodiment of FIG. 2, after the ring or vibration has been generated the main cell phone unit sends a signal to the HDD 232 to resume normal operations which is executed 234 by the HDD. As noted above in connection with FIG. 4, in at least some embodiments, the main cell phone unit will continue the process for determining whether or not to send further commands 216 until such time as the caller hangs up 442, or the “incoming call” state otherwise terminates.

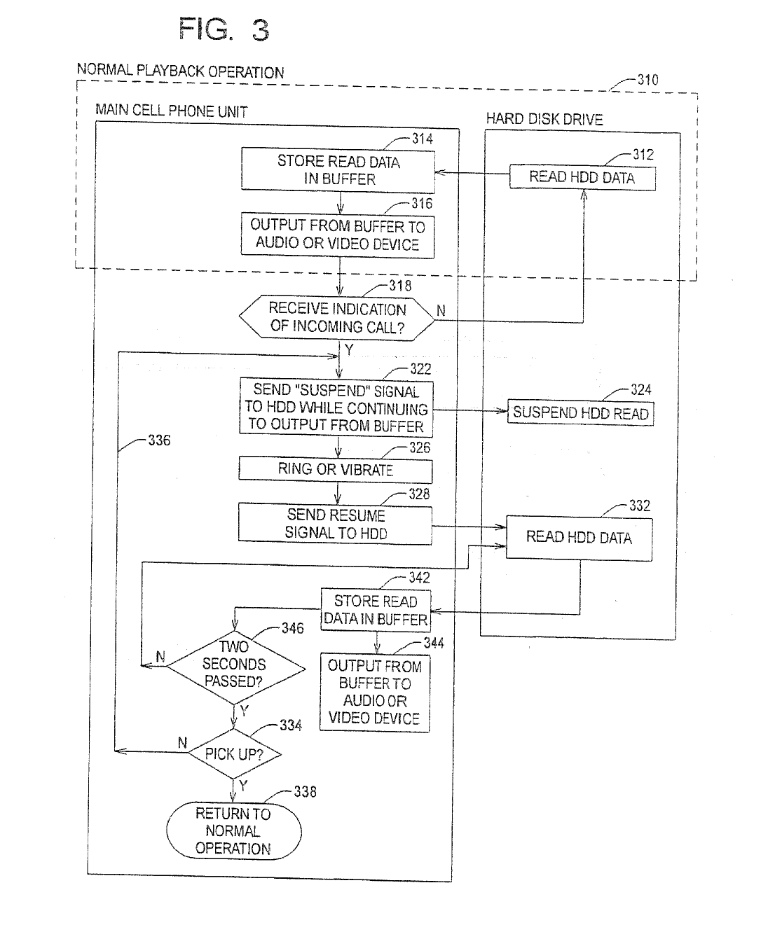

As noted above, in some configurations and/or situations, an HDD cell phone may be engaged in a playback of data, which is being sent from the HDD, at the time that suspend commands 216 are sent. FIG. 3 depicts a procedure in which interruptions in the playback can be substantially avoided or reduced. In the embodiment of FIG. 3, during normal operation 310, playback data which is read from the HDD 312 is first stored in a buffer 314, such as buffer 154 depicted in FIG. 1. Data is then output from the buffer 154 to the audio or video playback device 316 such as a speaker 132, display 144 or the like. This mode of operation continues in this fashion as long as there is no indication of an incoming call. However, once there is an indication of an incoming call 318, the main cell phone unit will send the suspend signal 216 (or other appropriate commands or signals), as discussed above, to the HDD while continuing to output the playback data from the buffer 154 (such that playback is not interrupted, despite suspension of HDD operations). The HDD and cell phone will continue to follow procedures, generally as shown in FIG. 2, until the ring or vibrate is generated 326 and the main cell phone unit sends a “resume” signal to the HDD 328. In order to avoid substantial interruption of the playback, the buffer 154 should have sufficient capacity to store the data required for playback between the time HDD operations are suspended and the time the resume signal is sent 328. This buffer size will depend upon the technology being used and may change as playback or other technology develops. As one example, however, the data rate for super-fine QVGA (quarter video graphics array) format is approximately 0.2 megabytes per second and the actual time from suspension of the HDD 324 until resuming HDD read 332 would typically not exceed a few seconds (and would typically be substantially less than 1 second).

In general, if the system is configured such that HDD operation only needs to be suspended prior to the first ring (e.g., if there is no vibrate mode for the cell phone or vibrate mode is automatically disabled during audio or video playback) then it will generally suffice, for operability, to provide a sufficiently large-capacity buffer as described above. However, when there is a likelihood of a series of closely spaced (e.g. about every two seconds 346) HDD suspensions (such as before each of a plurality of vibrations, until the user picks up or the caller hangs up 334), there must also be a 10 capacity to sufficiently replenish the contents of the buffer 154 so as to avoid playback interruption before and during the second and subsequent vibrations. As shown in FIG. 3 after the output of playback data from the HDD has been suspended 324 and then resumed 332, data from the HDD is once again stored into the buffer 154, for output to the audio or video device 344. In order to avoid interruption of playback during subsequent suspensions of HDD operations, the speed with which the buffer 154 is replenished after a suspension and resumption 324, 332 must be rapid enough that within the period from the resumption 332, following one ring 326, until the next suspension 324 associated with the next ring or vibrate, enough data must be added to the buffer 154 (taking into consideration the concurrent “loss” of data from the buffer or it is used for playback) to support substantially uninterrupted playback following the next suspend 324. The amount of data which must be stored in this period is generally as described above in connection with the first ring. The time during which this amount of data must be stored in the buffer 154 is no greater than the period of time between two subsequent cell phone rings or vibrations 346. For most configurations this period is about two seconds, the duration of a vibration being about one second. In those systems in which the suspension of HDD operation includes a spin-down operation and spin-up operation of the HDD, the time required for such operations must also be accommodated. In general, the relatively small-form-factor HDDs which are typically suitable for use in an HDD cell phone (such as the so-called “one inch” form factor HDD) have a relatively rapid spin-up time, such as about one-tenth of a second or less. As one example, the HDD transfer rate for system as described above would be on the order of 1.3 megabytes per second, which should suffice for supporting playback even of a high-throughput format such as super-fine QVGA.

A number of variations and modifications of the invention can be used. Embodiments have been described in which microprocessors 112,114 in conjunction with programming therefor form part or all of the circuitry which performs or achieves various procedures or goals. Those of skill in the art will understand that other circuitry can be provided for some or all of such procedures or goals including application specific integrated circuits (ASICs), configured programmable gate arrays and the like. Although a number of procedures have been described and/or depicted, it is possible to implement embodiments of the present invention which use other procedures, including procedures having more or fewer steps than those described and depicted and/or in which steps are performed in a different order. Although aspects of the present invention have been described in the context of a cell phone, some or all aspects of the present invention can be used in connection with other personal communication equipment including, e.g., radios, walkie-talkies, personal internet devices and the like. Although the present invention has been described in the context of an HDD mass storage device, some or all features of the present invention can be used in connection with other types of mass storage which may be susceptible to an EMI pulse, vibration and the like. Although examples have been provided in which various processes or steps are performed by the cell phone host and/or performed by the HDD, those of skill in the art will understand how to provide devices in which steps or procedures, of embodiments of the present invention, are otherwise distributed or performed.

In light of the above description a number of advantages of the present invention can be seen. The present invention makes it feasible to provide a cell phone with the advantages associated with a large capacity memory device such as an HDD, while avoiding loss or corruption of data and/or avoiding or eliminating damage to the HDD or other memory device. The present invention can provide protection for the HDD from malfunction or damage while substantially avoiding interruption or pause of data output or playback including audio or video playback.

The present invention, in various embodiments, includes components, methods, processes, systems and/or apparatus substantially as depicted and described herein, including various embodiments, sub-combinations, and subsets thereof. Those with skill in the art will understand how to make and use the present invention after understanding the present disclosure. The present invention, and various embodiments, includes providing the devices and processes in the absence of items not depicted and/or described herein or in various embodiments hereof, including in the absence of such items as may have been used in previous devices or processes, e.g., for improving performance, achieving ease of implementation and/or reducing cost of implementation. The present invention includes items which are novel, and terminology adapted from previous and/or analogous technologies, for convenience in describing novel items or processes, do not necessarily retain all aspects of conventional usage of such terminology.

The foregoing discussion of the invention has been presented for purposes of illustration and description. The foregoing is not intended to limit the invention to the forms or form disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. Apparatus, comprising:
a circuitry communicatively connected to a communication equipment and a storage device, the circuitry being configured to delay a communication equipment operation associated with an incoming communication at least until the circuitry receives an indication of a status of the storage device.

2. The apparatus of claim 1, wherein the communication equipment is a cellular phone.

3. The apparatus of claim 1, wherein the storage device is a hard disk drive.

4. The apparatus of claim 1, wherein the incoming communication is an incoming call.

5. The apparatus of claim 1, wherein the communication equipment operation is a ring operation.

6. The apparatus of claim 1, wherein the communication equipment operation is a vibrate operation.

7. The apparatus of claim 1, wherein the communication equipment operation is an operation related to generation of an electromagnetic interference (EMI) event.

8. The apparatus of claim 1, wherein the delay extends the communication equipment operation until the storage device completes at least a portion of a read/write operation.

9. The apparatus of claim 1, wherein the duration of the delay further depends upon the status of the storage device.

10. The apparatus of claim 1, wherein the storage device is further adapted to complete a read/write operation before providing the indication of the status of the storage device to the circuitry.

11. A method, comprising:
receiving, in a communication equipment, an indication of an incoming communication; and
delaying a communication equipment operation associated with the incoming communication at least until receipt of an indication of a status of a storage device;
wherein the storage device is communicatively connected to the communication equipment.

12. The method of claim 11, further comprising delaying the communication equipment operation based upon the status of the storage device.

13. The method of claim 11, wherein the communication equipment is a cellular phone.

14. The method of claim 11, wherein the storage device is a hard disk drive.

15. The method of claim 11, wherein the communication equipment operation is one of (1) a ring operation and (2) a vibrate operation.

16. The method of claim 11, wherein the communication equipment operation is an operation related to generation of an electromagnetic interference (EMI) event.

17. A communication equipment, comprising:
a circuitry configured to create a delay in a communication equipment operation associated with an incoming communication, wherein the delay postpones the communication equipment operation at least until the circuitry receives an indication of a status of a storage device.

18. The communication equipment of claim 18, wherein the storage device is a hard disk drive.

19. The communication equipment of claim 18, wherein the status of the storage device is completion of a read/write operation.

20. The communication equipment of claim 18, wherein the delay is based on the status of the storage device.
